(19) United States
(12) Patent Application Publication
(10) Pub. No.: US 2026/0360046 A1
(43) Pub. Date: Nov. 12, 2026

(54) METHOD, APPARATUS, DEVICE, MEDIUM, AND PRODUCT FOR GENERATING THREE-DIMENSIONAL SCENE

(71) Applicant: Beijing Zitiao Network Technology Co., Ltd., Beijing (CN)

(72) Inventors: Yingyu LI, Beijing (CN); Weichao WANG, Beijing (CN); Tianyang SHI, Beijing (CN); Hao HUANG, Beijing (CN); Zhouxing FANG, Beijing (CN); Wei HAN, Beijing (CN)

(21) Appl. No.: 19/672,272

(22) Filed: May 8, 2026

(30) Foreign Application Priority Data
May 8, 2025 (CN) 202510592879.1

(51) Int. Cl. G06T 11/60; G06T 17/00

(52) U.S. Cl. CPC G06T 11/60; G06T 17/00

(57) ABSTRACT

Embodiments of the present disclosure relate to a method, an apparatus, a device, a medium, and a product for generating a three-dimensional scene. The method includes determining a first image available for generating the three-dimensional scene. The method further includes determining a depth map corresponding to the first image based on the first image. The method further includes determining a three-dimensional mesh model corresponding to the first image based on the depth map and the first image. The method further includes determining the three-dimensional scene corresponding to the first image based on the first image and the three-dimensional mesh model.

### CROSS-REFERENCE TO RELATED APPLICATION(S)

This application claims priority to Chinese Application No. 202510592879. 1 filed in May 08, 2025, the disclosure of which is incorporated herein by reference in its entity.

### FIELD

Embodiments of the present disclosure generally relate to the field of information processing, and in particular, to a method, an apparatus, a device, a medium, and a product for generating a three-dimensional scene.

### BACKGROUND

Currently, artificial intelligence generated content (AIGC) technologies are rapidly developing in the field of digital content creation. In the directions of virtual scene construction, digital human creation, interactive media production, and the like, AI-driven automated content generation technologies are showing strong application potential. The technology achieves rapid output of high-quality content through deep learning algorithms, significantly improve the production efficiency of digital content, and bring new possibilities for the creative industry.

With the continuous progress of AIGC technologies, their capabilities in real-time rendering, multimodal fusion, and the like are constantly improving. Particularly in the field of three-dimensional (3D) content generation, technical solutions based on neural rendering and generative adversarial networks are becoming increasingly mature, and end-to-end generation from text and images to 3D models can be realized. These technological advances are driving the rapid development of emerging fields such as virtual image production and injecting new vitality into the digital content industry.

### SUMMARY

Embodiments of the present disclosure provide a method, an apparatus, a device, a medium, and a product for generating a three-dimensional scene.

A first aspect of the present disclosure provides a method for generating a three-dimensional scene. The method includes determining a first image available for generating the three-dimensional scene. The method further includes determining a depth map corresponding to the first image based on the first image. The method further includes determining a three-dimensional mesh model corresponding to the first image based on the depth map and the first image. The method further includes determining the three-dimensional scene corresponding to the first image based on the first image and the three-dimensional mesh model.

A second aspect of the present disclosure provides an apparatus for generating a three-dimensional scene. The apparatus includes a first image determination module configured to determine a first image available for generating the three-dimensional scene; a depth map determination module configured to determine a depth map corresponding to the first image based on the first image; a three-dimensional mesh model determination module configured to determine a three-dimensional mesh model corresponding to the first image based on the depth map and the first image; and a three-dimensional scene determination module configured to determine the three-dimensional scene corresponding to the first image based on the first image and the three-dimensional mesh model.

In third aspect of the present disclosure provides an electronic device. The electronic device includes at least one processor; and a storage apparatus for storing at least one program which, when executed by the at least one processor, causes the at least one processor to implement the method according to the first aspect of the present disclosure.

A fourth aspect of the present disclosure provides a computer-readable storage medium. The computer-readable storage medium has a computer program stored thereon, and the computer program, when executed by a processor, implements the method according to the first aspect of the present disclosure.

A fifth aspect of the present disclosure provides a computer program product. The computer program product includes a computer program which, when executed by a processor, implements the method according to the first aspect of the present disclosure.

It should be understood that the content described in this section is not intended to identify key or important features of the embodiments of the present disclosure, nor is it intended to limit the scope of the present disclosure. Other features of the present disclosure will become readily understood through the following description.

### BRIEF DESCRIPTION OF THE DRAWINGS

The above and other objects, features and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 illustrates a schematic diagram of an example environment in which the device and/or method of some embodiments of the present disclosure may be implemented;

FIG. 2 illustrates a schematic diagram of a method for generating a three-dimensional scene according to some embodiments of the present disclosure;

FIG. 3 illustrates a schematic diagram of another example method for generating a three-dimensional scene according to some embodiments of the present disclosure;

FIG. 4 illustrates a schematic diagram of text-to-image generation according to some embodiments of the present disclosure;

FIG. 5 illustrates a schematic diagram of image depth information extraction according to some embodiments of the present disclosure;

FIG. 6 illustrates a schematic diagram of three-dimensional mesh model conversion according to some embodiments of the present disclosure;

FIG. 7 illustrates a schematic diagram of three-dimensional scene generation according to a model and a map or a dynamic map according to some embodiments of the present disclosure;

FIG. 8 illustrates a schematic diagram of an image processing workflow according to some embodiments of the present disclosure;

FIG. 9 illustrates a schematic diagram of an image-to-video generation workflow according to some embodiments of the present disclosure;

FIG. 10 illustrates a schematic diagram of an image quality improvement workflow according to some embodiments of the present disclosure;

FIG. 11 illustrates a schematic diagram of a depth information extraction workflow according to some embodiments of the present disclosure;

FIG. 12 illustrates a schematic diagram of an interface for generating and exporting a model according to some embodiments of the present disclosure;

FIG. 13 illustrates a schematic block diagram of an apparatus for generating a three-dimensional scene according to some embodiments of the present disclosure; and

FIG. 14 illustrates a schematic block diagram of an example device suitable for implementing multiple embodiments of the present disclosure.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before using the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, when a proactive request of the user is received, prompt information is sent to the user to clearly prompt the user that the requested operation will require access to and use of the user’s personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the proactive request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, terms such as “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The terms “first”, “second”, etc. may refer to different or same objects. Other definitions, either explicit or implicit, may also be included below.

Generally, in a live streaming scene, a combination of virtual and real (real person image + virtual background) is a relatively new live streaming method. By producing different two-dimensional (2D) and three-dimensional (3D) virtual backgrounds, the live streaming effect of the streamer may be enriched, and the number of views may be increased. However, there are some problems in using the 2D virtual background for live streaming, for example, the viewing angle of the user is limited, only simple forward and backward camera movements may be performed, and the presentation form is relatively monotonous. The above problems may be avoided by using the virtual 3D background. However, there are also some problems in using the 3D virtual background for live streaming. For example, although the 3D virtual background has a good scene expressiveness, the production of a single 3D scene is relatively complicated, and the production may take weeks or even months, resulting in a long production cycle, low generation efficiency, and an inability to produce in a batch and at a high speed.

To this end, embodiments of the present disclosure provide a solution for generating a three-dimensional scene. In this solution, a computing device may first determine a first image available for generating the three-dimensional scene. Then, using the first image, a depth map corresponding to the first image may be determined. The computing device may then further process depth information in the depth map and the first image to generate a three-dimensional mesh model corresponding to the first image. Finally, the first image and the three-dimensional mesh model are further processed to generate the first scene corresponding to the first image. Through this method, the three-dimensional mesh model is generated using the depth map of the image and the image, and the three-dimensional scene corresponding to the image is obtained by combining the image with the three-dimensional mesh model, so that the three-dimensional scene may be generated more quickly, the batch production capability of the three-dimensional scene is improved, and the user experience is improved.

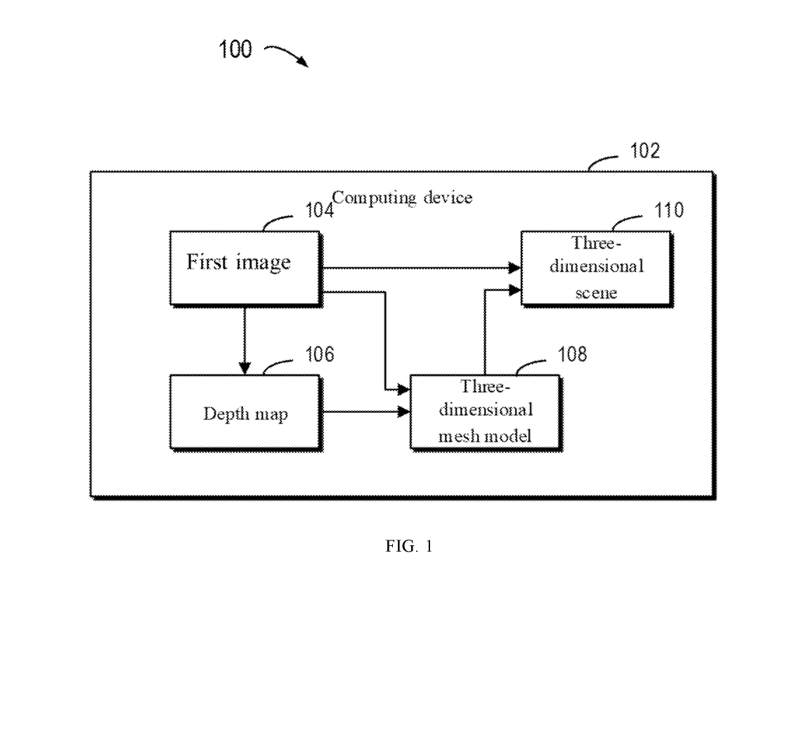

The embodiments of the present disclosure will be described in further detail below with reference to the drawings. FIG. 1 illustrates an example environment in which the device and/or method of the embodiments of the present disclosure may be implemented. In an environment 100, a computing device 102 may be used to generate a three-dimensional scene 110 corresponding to a first image 104.

Examples of the computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, to construct the three-dimensional scene 110, the computing device 104 needs to acquire the two-dimensional first image 104. The first image 104 may be an image that a user doing live streaming wants to use as a live streaming background. For example, the first image is an image of a live streaming stage. The user expects to use the image of the live streaming stage to generate a corresponding three-dimensional stage for use by the user.

Next, the computing device 102 may process the first image 104 to extract depth information corresponding to the image, thereby forming a corresponding depth map 106. The depth information of each pixel point in the depth map 106 represents distance information between an object in the image and a camera or an observer, and it adds third-dimensional spatial information to the two-dimensional image. Information of the first image in a depth direction is increased through the depth map.

After obtaining the depth map of the first image, computing device 102 may further use the depth map 106 to generate a three-dimensional mesh model corresponding to the first image. At this time, the computing device 102 may further use the first image 104 and the depth map 106 to construct the three-dimensional mesh model 108 for an object in the first image 104. Each object in the first image 104 may be represented by the three-dimensional mesh model 108. For example, if the first image 104 shows a stage, the three-dimensional mesh model 108 of the stage may be constructed using the depth map corresponding to the first image 104 and the first image 104.

Next, computing device 102 further processes the first image 104 and the generated three-dimensional mesh model 108 to generate the three-dimensional scene corresponding to the first image 104. In one example, the first image 104 and the three-dimensional mesh model 108 may be directly combined to generate a static three-dimensional scene. For example, the first image 104 for the stage and the three-dimensional mesh model corresponding to the stage are combined to form a three-dimensional stage as a live streaming scene. In another example, a video may also be generated according to the first image 104, and then the video is combined with the three-dimensional mesh model to form a dynamic three-dimensional scene. For example, a video for the stage is generated using the first image 104 for the stage, and the video dynamically shows the stage, including rotating to show the stage. Then, the video is combined with the three-dimensional mesh model of the stage to generate a dynamic display of the three-dimensional stage as the live streaming scene.

Through this method, the three-dimensional mesh model is generated using the depth map of the image and the image, and the three-dimensional scene corresponding to the image is obtained by combining the image with the three-dimensional mesh model, so that the three-dimensional scene may be generated more quickly, the batch production capability of the three-dimensional scene is improved, and the user experience is improved.

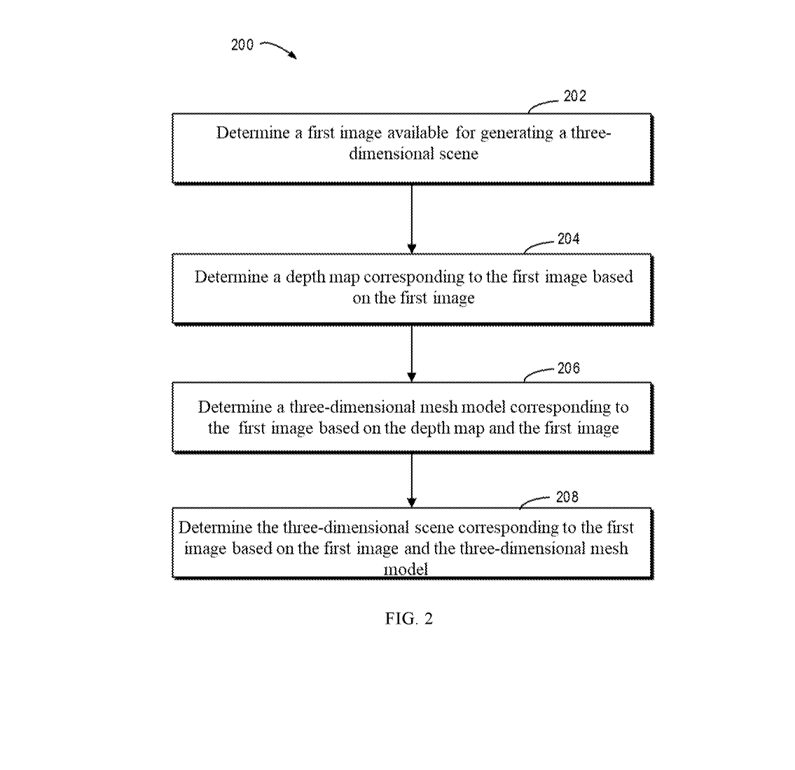

The schematic diagram of the example environment in which the device and/or method of some embodiments of the present disclosure may be implemented is described above with reference to FIG. 1, and the schematic diagram of the method for generating the three-dimensional scene according to some embodiments of the present disclosure is described below with reference to FIG. 2. The method in FIG. 2 may be performed by computing device 102 in FIG. 1 or any suitable computing device.

As shown in FIG. 2, in example method 200, at block 202, computing device 102 determines a first image available for generating a three-dimensional scene. To generate the three-dimensional scene, computing device 102 needs to acquire a first image. The first image may be acquired in various manners. In one example, a user doing live streaming may provide an image, for example, an image captured using a camera. In another example, computing device 102 may use a machine learning model to process input text to generate the first image. For example, computing device 102 may receive a text input by the user, for example, a prompt used to describe the first image. Then, computing device 102 inputs the input text into the machine learning model to generate the first image. The machine learning model may also be referred to as a first machine learning model. For example, the first machine learning model may be a text-to-image model.

After acquiring the first image 104, computing device 102 may perform further processing on the first image 104. For example, the image provided by the user is captured by a camera, and the hardware parameters of some cameras are not ideal, resulting in problems such as blurred imaging, low quality, and an insignificant region of interest in the captured image. To solve the above problems, the computing device 102 may perform image super-resolution processing on the first image to update the first image or increase the resolution of the first image. The image super-resolution processing restores a given low-resolution first image to a corresponding high-resolution image by a predetermined operation. For example, digital image processing, computer vision, and other technologies are used, in combination with a predetermined processing algorithm, to reconstruct a low-resolution image into a high-resolution image.

At block 204, the computing device 102 determines a depth map corresponding to the first image based on the first image. To be able to generate the three-dimensional scene, the computing device 102 needs to further acquire the depth map corresponding to the first image, to increase depth information related to the three-dimensional scene.

Multiple implementations are possible for acquiring the depth map of the first image. In one example, the computing device 102 may first acquire a pre-trained machine learning model for generating a depth map from an image. For ease of description, the machine learning model is also referred to as a second machine learning model. The second machine learning model may be trained using a pre-marked sample image and a sample depth map. Then, the computing device 102 may input the first image 104 into the second machine learning model to obtain the depth map. The second machine learning model may be any suitable machine learning model.

In another example, when determining the depth map corresponding to the first image, the computing device 102 may first extract depth information from the first image 104. For example, the depth information for each pixel point is extracted from the first image. Then, the computing device 102 uses the depth information to generate the depth map for the first image. For example, the first image is input into a loaded model, and the model performs feature extraction and analysis on the image, and learns textures, edges, and contextual information in the image, thereby predicting a depth value corresponding to each pixel. Then, the depth value output by the model is converted into an appropriate data type and range, which is usually normalized to an interval of 0-255 to facilitate subsequent processing and display. Finally, the depth map is created according to the normalized depth value. A grayscale value of each pixel in the map represents the depth information of a corresponding position of the pixel in the original image. A brighter pixel indicates a closer distance, and a darker pixel indicates a farther distance.

At block 206, the computing device 102 determines a three-dimensional mesh model corresponding to the first image based on the depth map and the first image. After obtaining the depth map, the computing device 102 further, in combination with the first image, and uses the depth map and the first image to further generate the three-dimensional mesh model of the object in the first image.

In some embodiments, the computing device 102 may input the depth map and the first image into a pre-trained machine learning model to generate the three-dimensional mesh model corresponding to the first image. The machine learning model may be any suitable model.

In some embodiments, the computing device 102 may first extract the depth information of each pixel in the depth map, and determine the position of each point on the object surface in the three-dimensional space according to the depth value. For example, a point corresponding to a relative bright pixel in the depth map is closer to the camera and is in a front position in the three-dimensional space, while a point corresponding to a relative dark pixel is farther from the camera and is in a rear position in the three-dimensional space. Then, based on the color and texture information of the first image, corresponding color and material attributes are given to the points in the three-dimensional space. For example, if a certain area in the first image is red, the point at the corresponding position in the three-dimensional space is given a red material. Next, these points may be connected to form a triangular mesh according to the position information of each point in the depth map. For example, adjacent points are connected according to certain rules to construct the surface of the object. For example, for adjacent points in the depth map with similar depth, their positions in the three-dimensional space are also adjacent. These points are connected into triangles, and multiple triangles are combined to form the surface mesh of the object. In the process of constructing the triangular mesh, texture mapping may also be performed on the mesh according to the texture information of the first image, so that the generated three-dimensional mesh model has a similar appearance to the original image.

At block 208, the computing device 102 determines the three-dimensional scene corresponding to the first image based on the first image and the three-dimensional mesh model. After the three-dimensional mesh model corresponding to the first image being obtained, the computing device 102 further uses the first image and the three-dimensional mesh model to generate the three-dimensional scene corresponding to the first image.

In some embodiments, the computing device 102 directly combines the first image into the three-dimensional mesh model to generate the three-dimensional scene corresponding to the first image. For example, the first image is combined into the three-dimensional mesh model as a map to generate the static three-dimensional scene corresponding to the first image.

In some embodiments, the computing device 102 may further use the first image to generate a video corresponding to the first image. In one example, the computing device 102 applies the first image to a third machine learning model to generate the video corresponding to the first image. In another example, the computing device 102 may further acquire another image corresponding to the first image, and then perform an interpolation operation on the first image and another image to generate multiple video frames to form the video corresponding to the first image. Then, the computing device 102 determines the three-dimensional scene corresponding to the first image using the video and the three-dimensional mesh model. For example, each video frame in the video is combined with the three-dimensional mesh model to generate the dynamic three-dimensional scene. Additionally, the computing device 102 may further perform image super-resolution processing on the video frames in the obtained video to update the video.

Through this method, the three-dimensional mesh model is generated using the depth map of the image and the image, and the three-dimensional scene corresponding to the image is obtained by combining the image with the three-dimensional mesh model, so that the three-dimensional scene may be generated more quickly, the batch production capability of the three-dimensional scene is improved, and the user experience is improved.

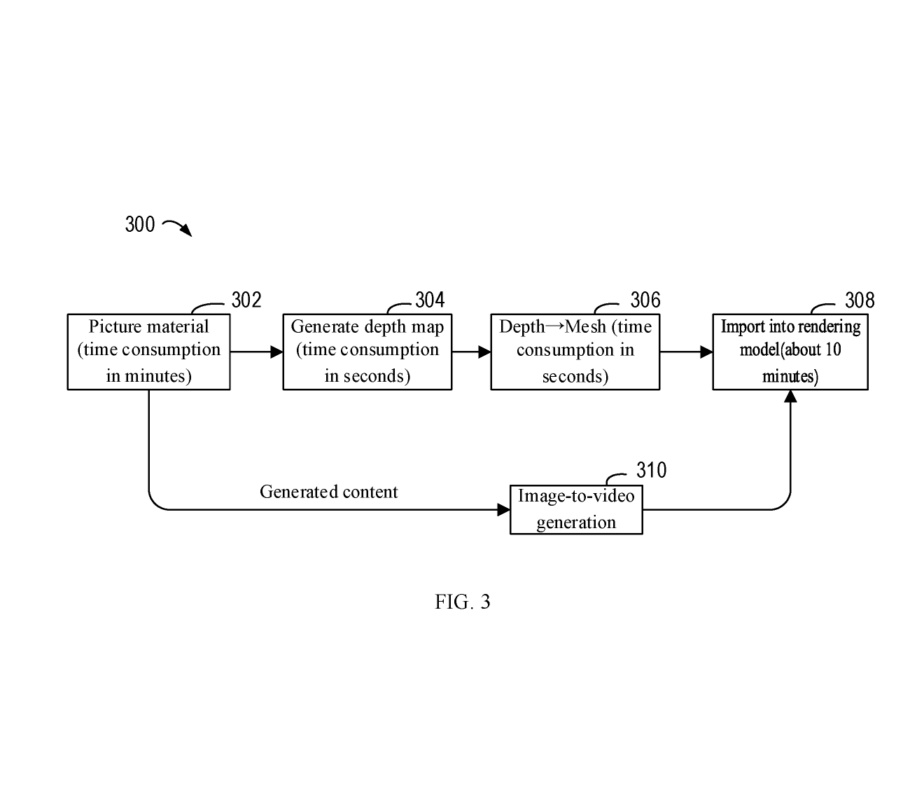

The schematic diagram of the method for generating the three-dimensional scene according to some embodiments of the present disclosure is described above with reference to FIG. 2, and the flowchart of another example method for generating the three-dimensional scene according to some embodiments of the present disclosure is described below with reference to FIG. 3. The example method 300 in FIG. 3 may be processed by the computing device 102 in FIG. 1 or any suitable computing device.

First, the computing device 102 receives, at block 302, a picture material in a common format, such as jpg or png, as input. These picture materials may be generated through the AIGC technology, or may be acquired from an existing picture library, such as a photographic image or a digital drawing. These pictures have good generality and controllability, and their preparation time is usually within a range of minutes. Subsequently, the computing device 102 uses any suitable depth estimation model to process the input image. Such a model may accurately predict the depth information of each pixel point from a single image or multiple images, and then generate a corresponding depth map at block 304. This step has high computational efficiency, and the processing time may be controlled within seconds, which may provide an accurate geometric basis for the subsequent three-dimensional reconstruction.

After obtaining the depth map, the computing device may convert the depth information into a three-dimensional mesh model at block 306 through a three-dimensional reconstruction tool, and the conversion process may also be completed within seconds. The generated mesh model is output in a predetermined format for subsequent editing and use. Finally, the computing device imports the processed 3D model into a mainstream rendering engine at block 308, and the entire process of importing and scene construction takes about ten minutes, which greatly shortens the production cycle compared with the traditional manual modeling method.

In addition, at block 310, the computing device 102 further integrates the AIGC technology to implement an image-to-video function. By inputting key frames at the beginning and the end, the computing device 102 may automatically generate intermediate frames and synthesize continuous and natural dynamic video content, simulating complex animation effects such as camera pushing, angle rotation, and light variation, which greatly enriches the expressiveness and immersion of the virtual live streaming scene. A dynamic three-dimensional scene may be generated by combining the generated video with the three-dimensional mesh model at block 308.

Through this method, a fully automated process from a static image to a complete three-dimensional virtual scene is realized, covering key steps such as image input, depth prediction, three-dimensional reconstruction, model engine import, and video generation. The cost time of the entire process is compressed to several minutes, which significantly improves the efficiency and large-scale capability of content generation, and improves the user experience.

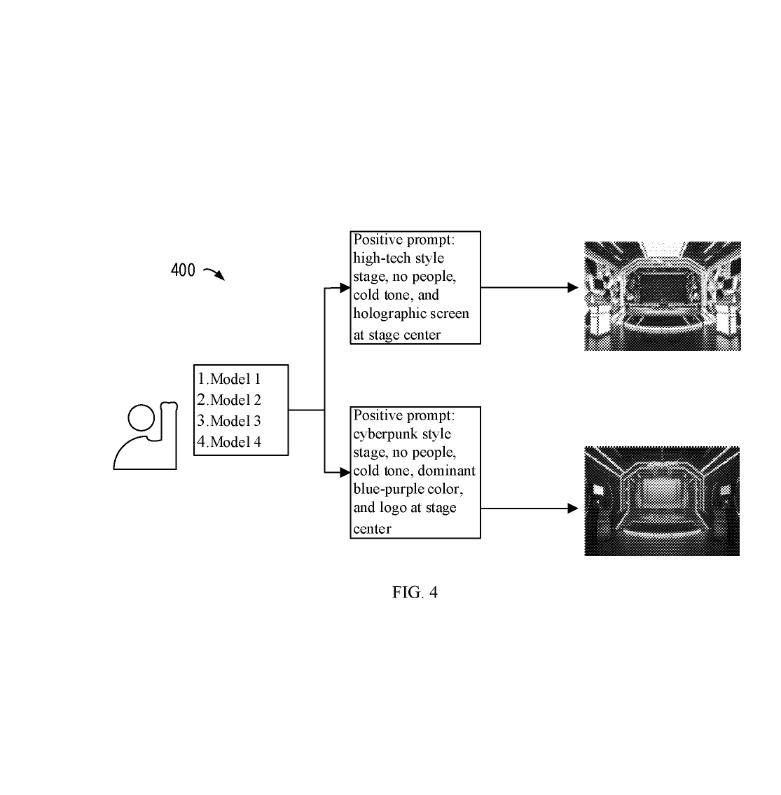

The flowchart of another example method for generating the three-dimensional scene according to some embodiments of the present disclosure is described above with reference to FIG. 3, and the schematic diagram of text-to-image generation according to some embodiments of the present disclosure is described below with reference to FIG. 4. The example process 400 in FIG. 4 may be performed by the computing device 102 shown in FIG. 1 or any suitable device.

In example 400, this example shows a solution of using an artificial intelligence drawing tool to generate a high-tech style stage scene. As shown in the figure, the computing device 102 realizes directional generation of the scene through precise prompt control. A positive prompt may be given to clearly require the generation of an unmanned scene of "high-tech style stage, cold tone, and holographic screen at center of stage". A positive prompt of "cyberpunk style, no people, cold tone, dominant blue-purple color, and logo at center of stage" may also be given, and a high consistency between the generated result and the target style is ensured. This prompt mechanism may effectively guide the AI model to output background materials that meet the requirements of the live streaming scene, and provide a high-quality 2D plane material basis for the subsequent 3D scene conversion. The images generated by the AI tool will be screened uniformly, and the best result will enter the subsequent depth map generation and 3D conversion process. Compared with the traditional manual background drawing, this solution has significantly improved efficiency, the time-consuming for a single generation may be controlled within minutes, and it supports rapid iteration of different styles by adjusting the prompt, providing a large amount of basic materials that are simple, easy to obtain, and in line with expectations.

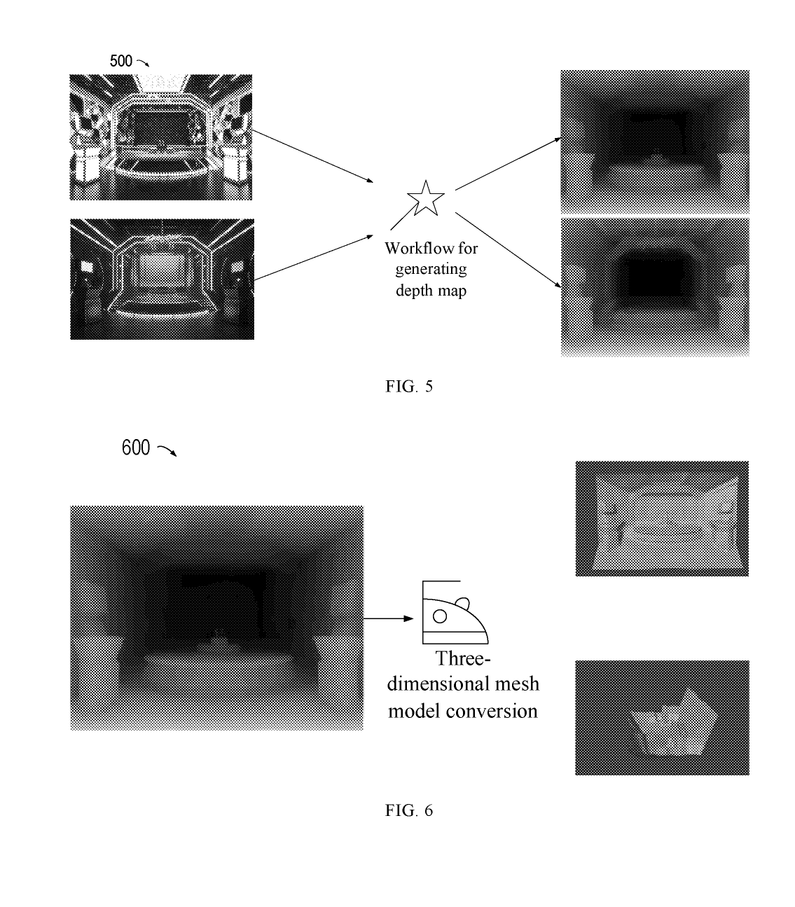

The schematic diagram of image depth information extraction according to some embodiments of the present disclosure is described below with reference to FIG. 5. In example 500, the computing device 102 uses a workflow for generating the depth map to extract the image depth information. Specifically, the computing device first builds a customized workflow by a visual node editor, and integrates the depth estimation model into a processing pipeline. After a two-dimensional image is input, the depth estimation model performs real-time depth information calculation, and generates a corresponding depth map. A close-up area of the image is represented by a relative light gray value, and a long-shot area is represented by a relative dark gray value. This AI-based depth extraction method has significant advantages over the traditional stereo vision algorithm. It not only may process monocular image input, but also maintains high accuracy and robustness. As basic data for subsequent three-dimensional mesh reconstruction, the quality of the generated depth map directly affects the realism and stereoscopic effect of the final 3D scene. Through the graphical interface, the user may intuitively monitor the processing process, and adjust parameter configuration as needed to ensure that the depth extraction result meets the requirements of different application scenes.

The schematic diagram of three-dimensional mesh model conversion according to some embodiments of the present disclosure is described below with reference to FIG. 6. In example 600, the computing device 102 converts the depth map generated previously into an editable three-dimensional mesh model. Specifically, the computing device first imports the depth map output by the depth estimation model and the original color image into a conversion model together, and by a depth-to-mesh function of a three-dimensional modeling assistant plugin, automatically generates a three-dimensional mesh surface with a spatial topological structure based on the depth information of the image. The generated three-dimensional mesh model not only retains the visual features of the original image, but also has a reasonable geometric structure, and may support secondary editing and optimization in authoring software. The algorithm optimization at this step achieves a conversion speed of seconds, which is greatly improved in efficiency compared with the traditional manual modeling method, and provides key technical support for quickly building three-dimensional scenes. Finally, a model in a predetermined format is output, which may be directly imported into a real-time rendering engine to complete subsequent scene construction and dynamic map production.

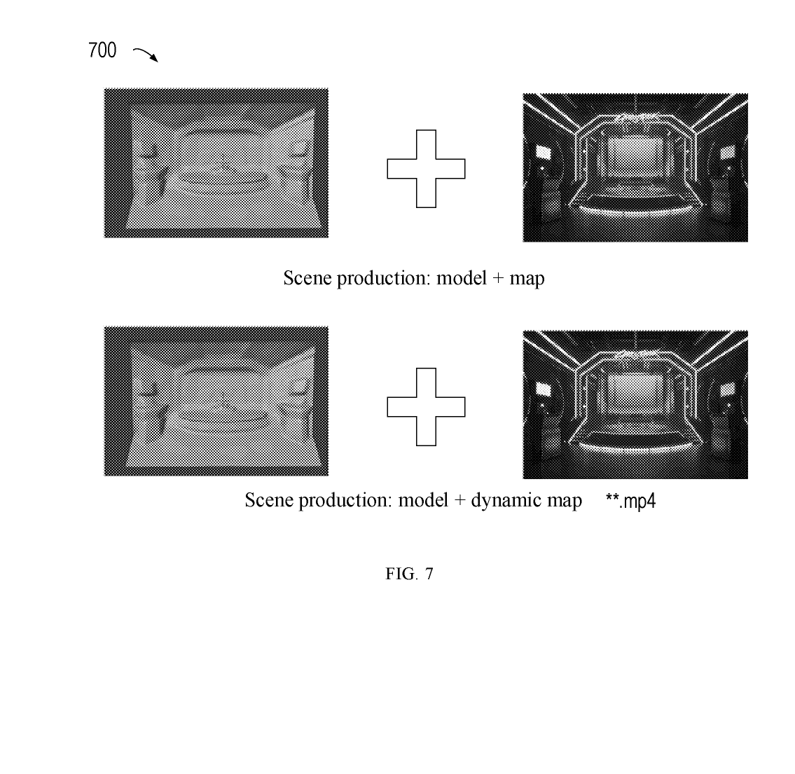

The schematic diagram of three-dimensional scene generation according to a model and a map or a dynamic map according to some embodiments of the present disclosure is described below with reference to FIG. 7. In example 700, the computing device 102 uses an intelligent integration technology of model and map to implement an efficient three-dimensional scene construction process. The computing device first imports the generated optimized three-dimensional model in the predetermined format to ensure that performance requirements may be met while maintaining visual accuracy, and uses a dynamic video sequence generated by the AIGC as texture input to implement real-time rendering and playing of video map, and supports adjustment of all related parameters. At the same time, a static map may also be directly used as texture input to complete scene production. In the scene synthesis stage, a visual programming system is used to control interaction logic, so that non-technical personnel may quickly complete scene parameter adjustment, and finally output a complete virtual scene supporting high-resolution live streaming.

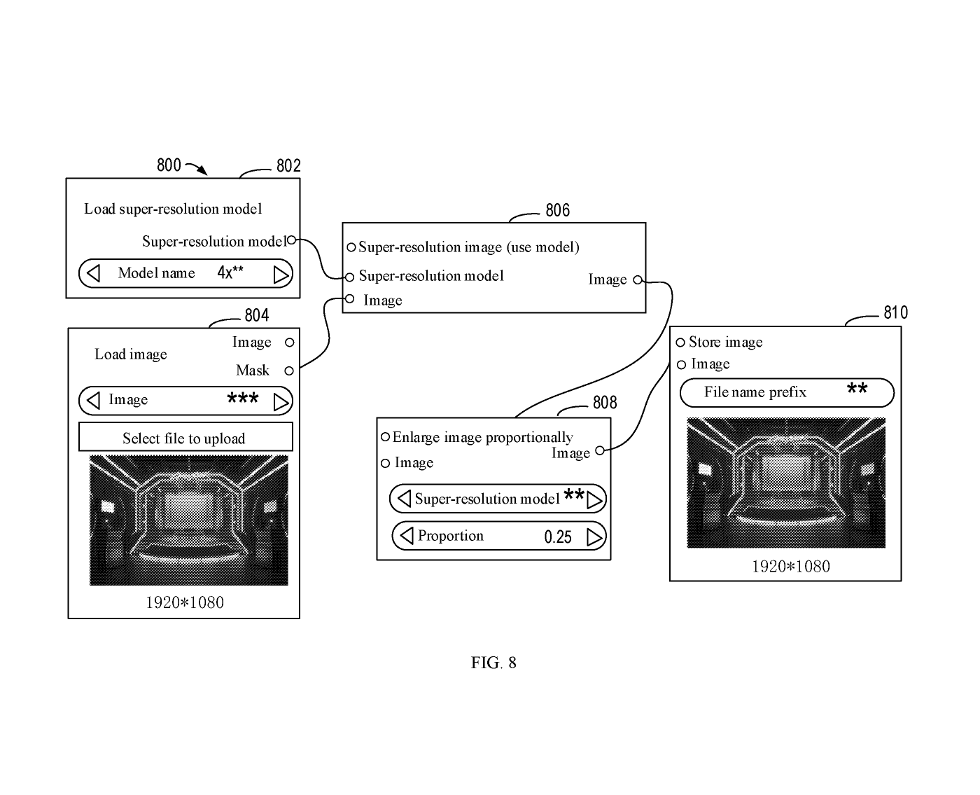

The schematic diagram of the image processing workflow according to some embodiments of the present disclosure is described below with reference to FIG. 8. Example 800 mainly includes key processing steps such as loading a super-resolution model, loading an image, super-resolution image processing, image enlargement, and storing the image. At 802, the computing device loads a specified super-resolution model, which may first optimize a scene image, support four times of enlargement, and effectively suppress shadows while maintaining sharpness. At block 804, the uploaded image is loaded, and mask local processing is supported to achieve selective enhancement. Then, at block 806, the super-resolution model and the loaded image are received and input together to block 808. Then, at block 808, the first image is enlarged proportionally at a user-defined enlargement ratio. Finally, at block 810, the enlarged image is stored.

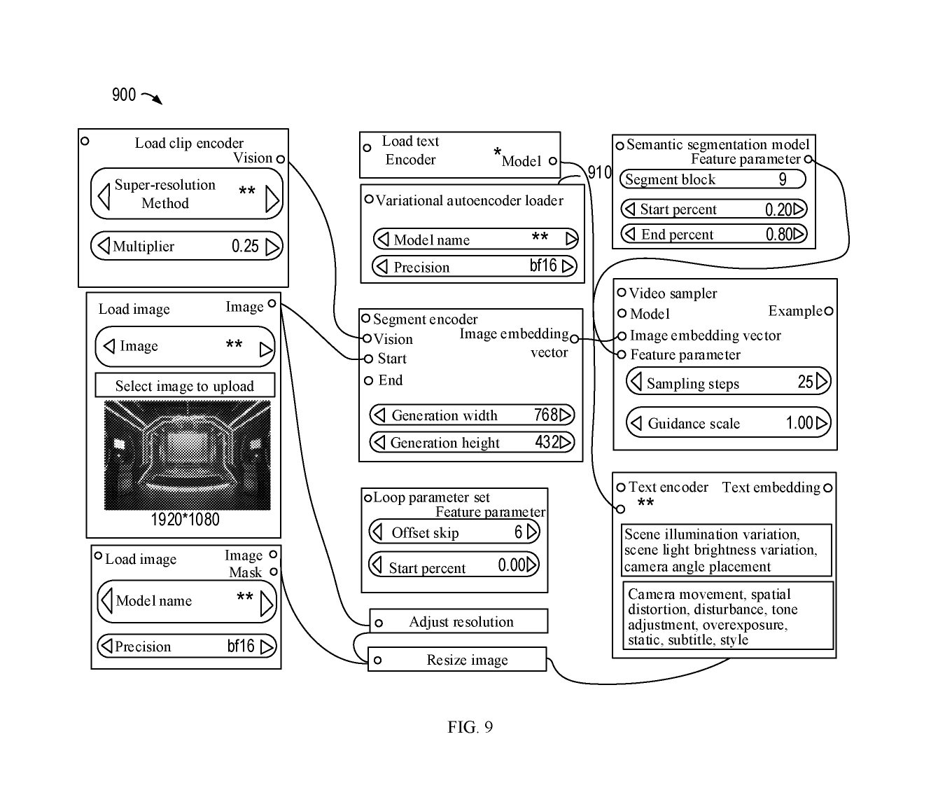

The schematic diagram of the image-to-video generation workflow according to some embodiments of the present disclosure is described below with reference to FIG. 9. In example 900, the computing device 102 first loads a clip encoder and configures basic parameters, including selecting a substantially predetermined super-resolution algorithm, setting a scaling ratio of 0.25, and specifying a main processing device. The workflow uses an image with a resolution of 1920*1080 as an input source, and implements content parsing through a multi-modal encoding processing system. For visual encoding, a corresponding model and a variational autoencoder with bf16 precision is used, and for text encoding, a predetermined model is integrated to process scene description text. The computing device sets up a fine parameter control system, including defining a generation size of 768×432, configuring a loop parameter set, and a segment block processing strategy of a semantic segmentation model. The video sampler changes multiple parameter to achieve content optimization. The workflow also supports a variety of post-processing functions, including visual enhancement options such as camera movement effects, spatial warping, and tone adjustment, as well as stylization processing such as static image and subtitle overlay. The entire workflow uses bf16 precision to balance computing efficiency and output quality, and ensures content consistency through the collaborative work of multiple models. Its modular design supports full-process processing from material input to 4K-level super-resolution output.

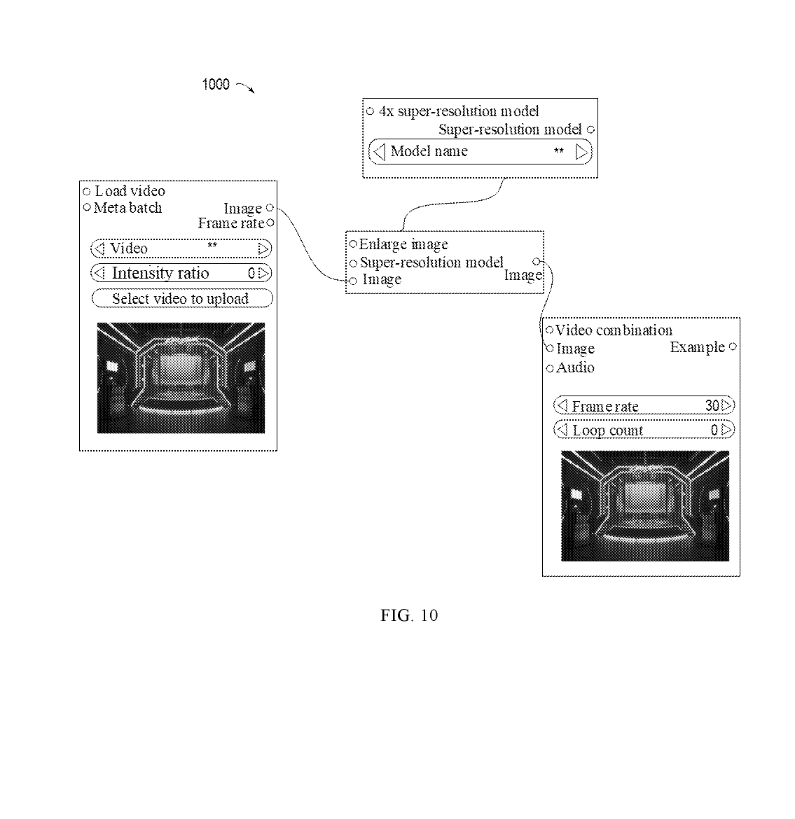

The schematic diagram of the workflow for image quality improvement according to some embodiments of the present disclosure is described below with reference to FIG. 10. In example 1000, the computing device 102 first loads a pre-trained super-resolution model, which is specially designed to achieve high-quality four-time image enlargement. The processing flow uses a video file as an input source, and the video specification includes a standard frame rate of 30 frames per second. The system splits the video into frames through a processing module, converts a continuous video stream into a single frame image sequence, and then calls the variational autoencoder to perform feature extraction and enhancement processing on each frame of image. At the core processing step, the super-resolution model performs four-time resolution improvement on each frame of image, while maintaining the details and clarity of the original image. The system supports user-defined processing parameters, including options such as setting the processing intensity (initial value is 0) and the loop count. After the processing is completed, the system may re-synthesize the enhanced image sequence into a high-resolution video output, and supports re-synchronization with the audio track. The entire workflow implements automated conversion from standard resolution video to high-definition video. While maintaining the original frame rate, the video resolution may be increased to four-times original size, effectively enhancing the video effect.

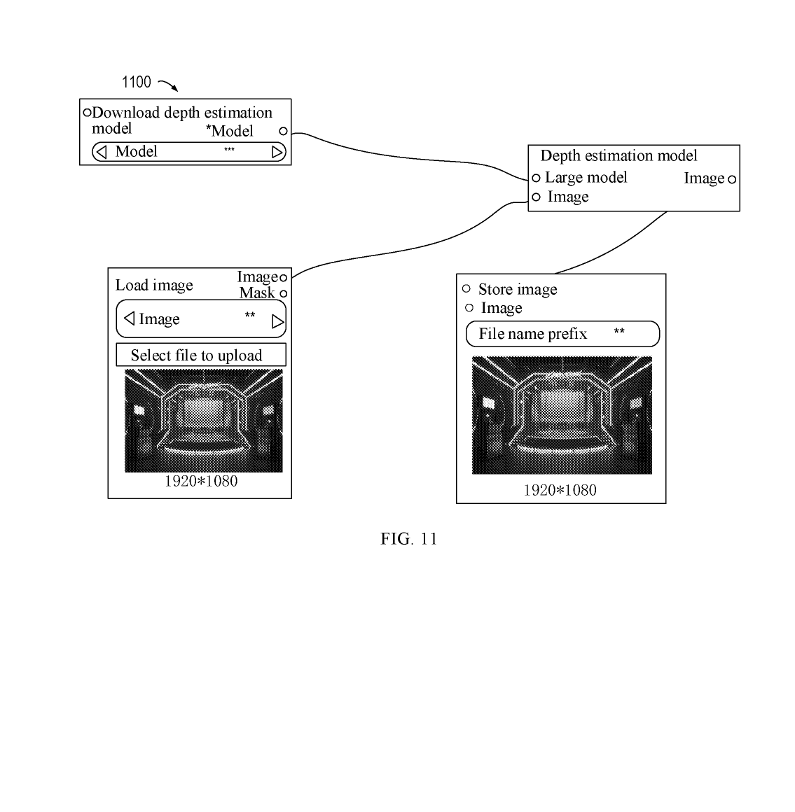

The schematic diagram of the workflow for depth information extraction according to some embodiments of the present disclosure is described below with reference to FIG. 11. In example 1100, the computing device 102 first loads the depth estimation model, which is dedicated to extracting accurate depth information from a single image. The processing flow uses an image with a resolution of 1920*1080 as an input source, and supports the user to select an image file to be processed through a file upload interface. The computing device 102 directly uses the depth estimation model to perform depth estimation. During the processing, the system supports a mask function, which allows the user to specify a specific area for priority processing or exclusion. After completing the depth estimation, the computing device 102 generates a corresponding depth map, and the output file will be automatically prefixed for easy identification and management, while maintaining the 1920*1080 resolution specification of the original image. This workflow significantly improves the efficiency of the traditional depth estimation process through automated processing, and may provide a higher-quality depth data basis for subsequent three-dimensional modeling and virtual scene synthesis.

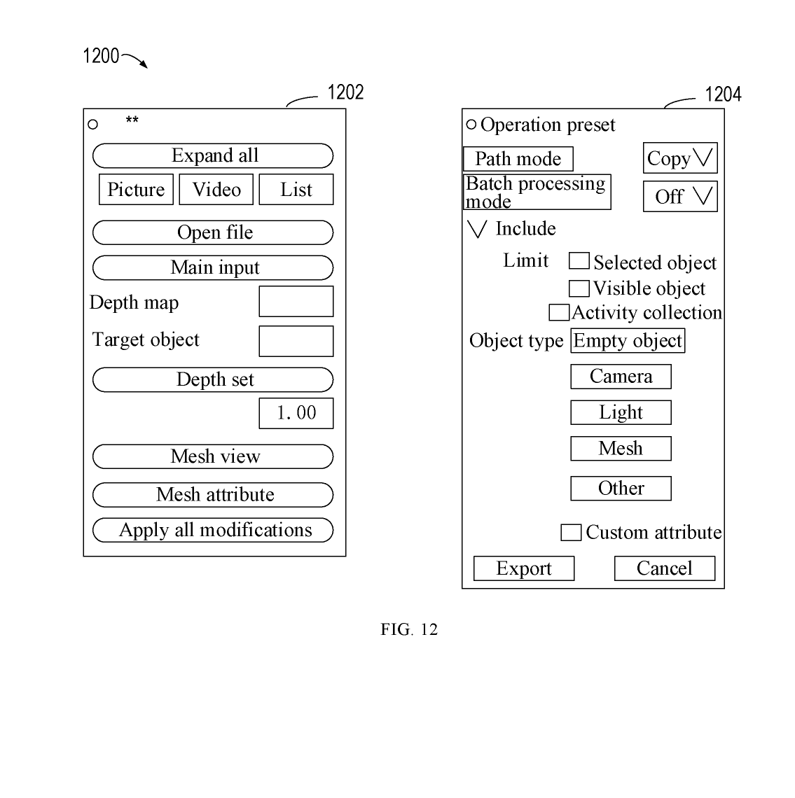

The schematic diagram of the interface for generating and exporting the model according to some embodiments of the present disclosure is described below with reference to FIG. 12. In example 1200, block 1202 is a function panel for generating a stereo model, and block 1204 is a function panel for exporting the model. The two panels mainly include multiple function modules such as file operation, depth map setting, mesh view control, and export parameter configuration. The computing device 102 first provides a file management option, supports expanding and browsing of pictures, videos, and lists, and the user may select a main input source by an "open file" button. In the setting area of a depth map, the user may specify a target object and adjust a depth parameter. The mesh view portion includes mesh attributes and modifier application options, which allows the user to perform final adjustment on the three-dimensional mesh. The operation preset area provides multiple processing mode selections, including a path mode, a copy function, and a batch processing switch. The computing device 102 also provides fine export range control, which supports limiting the export of selected objects, visible objects, or activity collections. In object type filtering, the user may select to export multiple three-dimensional elements such as empty objects, cameras, lights, bones, and meshes, and supports retention of custom attributes. Two operation buttons, "export" and "cancel", are provided at the bottom of the interface, which are used to confirm or terminate the export process. The entire panel uses a hierarchical design, and arranges complex export parameters in groups according to functional logic, which not only ensures precise control on export settings by professional users, but also reduces operation difficulty through a clear interface layout. This functional module is especially suitable for a workflow that needs to export three-dimensional scenes in a predetermined format for cross-platform collaboration, and provides a simple and convenient interactive operation scene for the production of three-dimensional backgrounds.

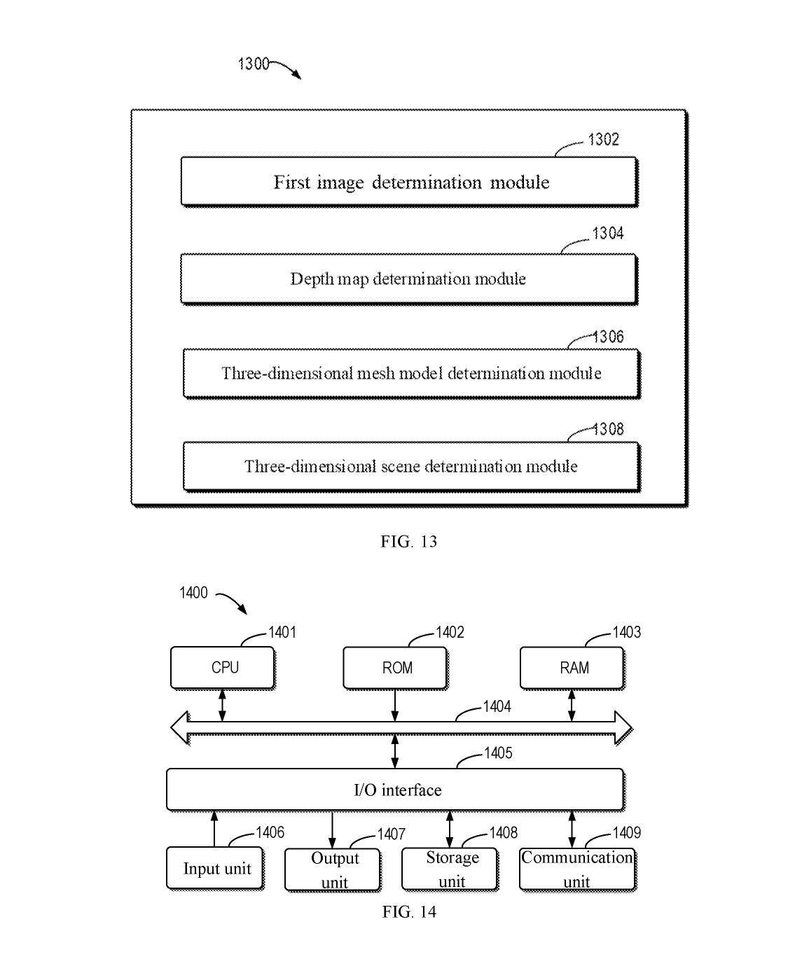

FIG. 13 illustrates a schematic block diagram of an apparatus for generating a three-dimensional scene according to some embodiments of the present disclosure. The apparatus 1300 shown in FIG. 13 may be implemented in computing device 102 in FIG. 1. As shown in FIG. 13, the apparatus 1300 includes a first image determination module 1302 configured to determine the first image available for generating the three-dimensional scene; a depth map determination module 1304 configured to determine a depth map corresponding to the first image based on the first image; a three-dimensional mesh model determination module 1306 configured to determine the three-dimensional mesh model corresponding to the first image based on the depth map and the first image; and a three-dimensional scene determination module 1308 configured to determine the three-dimensional scene corresponding to the first image based on the first image and the three-dimensional mesh model.

In some embodiments, the first image determination module 1302 includes a prompt receiving module and a first image generation module. The prompt receiving module is configured to receive a prompt used to describe the first image. The first image generation module is configured to generate the first image by inputting the prompt into a first machine learning model.

In some embodiments, the apparatus 1300 further includes a resolution processing module. The resolution processing module is configured to perform image super-resolution processing on the first image to update the first image.

In some embodiments, the depth map determination module 1304 includes a depth information extraction module and a first depth map module. The depth information extraction module is configured to extract depth information from the first image. The first depth map module is configured to determine the depth map for the first image based on the depth information.

In some embodiments, the depth map determination module 1304 includes a second depth map module. The second depth map module is configured to obtain the depth map by inputting the first image into a second machine learning model.

In some embodiments, the three-dimensional scene determination module 1308 includes a first scene determination module. The first scene determination module is configured to generate the three-dimensional scene corresponding to the first image by combining the first image into the three-dimensional mesh model.

In some embodiments, the three-dimensional scene determination module 1308 includes a video determination module and a second scene determination module. The video determination module is configured to generate a video corresponding to the first image based on the first image. The second scene determination module is configured to determine the three-dimensional scene corresponding to the first image based on the video and the three-dimensional mesh model.

In some embodiments, the video determination module includes a first video determination module. The first video determination module is configured to generate the video corresponding to the first image by applying the first image to a third machine learning model.

In some embodiments, the apparatus 1300 further includes an update module. The update module is configured to update the video by performing image super-resolution processing on a video frame in the video to.

In some embodiments, the second scene determination module includes a second combination module. The second combination module is configured to generate the three-dimensional scene by combining each video frame in the video into the three-dimensional mesh model.

FIG. 14 illustrates a schematic block diagram of an example device 1400 that may be used to implement the embodiments of the present disclosure. Computing device 102 in FIG. 1 may be implemented using the device 1400. As shown in the figure, the device 1400 includes a central processing unit (CPU) 1401, which may perform various appropriate actions and processing according to computer program instructions stored in a read-only memory (ROM) 1402 or computer program instructions loaded from a storage unit 1408 into a random access memory (RAM) 1403. The RAM 1403 may also store various programs and data required for the operations of the device 1400. The CPU 1401, the ROM 1402, and the RAM 1403 are connected to each other via a bus 1404. An input/output (I/O) interface 1405 is also connected to the bus 1404.

Multiple components in the device 1400 are connected to the I/O interface 1405, and the components include: an input unit 1406, such as a keyboard and a mouse; an output unit 1407, such as various types of displays and speakers; the storage unit 1408, such as a magnetic disk and an optical disc; and a communication unit 1409, such as a network card, a modem, and a wireless communication transceiver. The communication unit 1409 allows the device 1400 to exchange information/data with other devices via a computer network such as the Internet and/or various telecommunication networks.

The various processes and treatments described above, such as methods 200 and 300, may be performed by processing unit 1401. For example, in some embodiments, methods 200 and 300 may be implemented as computer software programs tangibly contained in a machine-readable medium, such as the storage unit 1408. In some embodiments, a portion or an entirety of the computer program may be loaded and/or installed into the device 1400 via the ROM 1402 and/or the communication unit 1409. When the computer program is loaded into the RAM 1403 and executed by the CPU 1401, one or more actions of the example methods 200 and 300 described above may be performed.

The present disclosure may be a method, an apparatus, a system, and/or a computer program product. The computer program product may include a computer-readable storage medium having computer-readable program instructions for performing various aspects of the present disclosure stored thereon.

The computer-readable storage medium may be a tangible device that may hold and store instructions for use by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punched card or a raised structure in a groove having instructions stored thereon, and any suitable combination thereof. The computer-readable storage medium used herein is not interpreted as a transitory signal itself, such as a radio wave or other freely propagating electromagnetic waves, the electromagnetic waves propagating through waveguides or other transmission mediums (for example, light pulses through optical fiber cables), or electrical signals transmitted through wires.

The computer-readable program instructions described herein may be downloaded from the computer-readable storage medium to various computing/processing devices, or downloaded to an external computer or an external storage device via a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a computer of a user, executed partly on the computer of the user, executed as an independent software package, executed partly on the computer of the user and partly on a remote computer, or executed entirely on the remote computer or a server. In the case involving the remote computer, the remote computer may be connected to the computer of the user through any kind of network, including a local area network (LAN) or a wide area network (WAN), or may be connected to an external computer (for example, connected by using Internet provided by an Internet service provider). In some embodiments, by using the state information of the computer-readable program instructions to customize an electronic circuit, such as a programmable logic circuit, a field programmable gate array (FPGA), or a programmable logic array (PLA), the electronic circuit may execute the computer-readable program instructions, thereby implementing various aspects of the present disclosure.

Various aspects of the present disclosure are described herein with reference to flowcharts and/or block diagrams of methods, apparatuses (systems), and computer program products according to the embodiments of the present disclosure. It should be understood that each block of the flowchart and/or block diagram, and a combination of the blocks in the flowchart and/or block diagram may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing a function/action specified in one or more blocks in the flowchart and/or block diagram. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the function/action specified in one or more blocks in the flowchart and/or block diagram.

The computer-readable program instructions may also be loaded onto a computer, another programmable data processing apparatus, or other devices, so that a series of operation steps are performed on the computer, the other programmable data processing apparatus, or the other devices to produce a computer-implemented process, such that the instructions executed on the computer, other programmable data processing apparatus, or other device implement the function/action specified in one or more blocks in the flowchart and/or block diagram.

The flowcharts and block diagrams in the drawings show the possibly implemented architectures, functions, and operations of the system, the method, and the computer program product according to multiple embodiments of the present disclosure. In this regard, each block in the flowchart or block diagram may represent a module, a program segment, or a portion of an instruction, and the module, the program segment, or the portion of which contains one or more executable instructions for implementing a specified logical function. In some alternative implementations, the functions marked in the blocks may also occur in an order different from that marked in the drawings. For example, two consecutive blocks may actually be performed substantially in parallel, or they may sometimes be performed in a reverse order, depending on the functions involved. It should also be noted that each block of the block diagram and/or the flowchart, and a combination of the blocks in the block diagram and/or the flowchart may be implemented by a special-purpose hardware-based system that executes specified functions or actions, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the described embodiments, many modifications and variations will be apparent to those of ordinary skill in the art. The terms used herein are selected to best explain the principles of the embodiments, the actual applications or technical improvements to the technologies in the market, or to enable other persons of ordinary skill in the art to understand the embodiments disclosed herein.

We claim:

1. A method for generating a three-dimensional scene, comprising:
determining a first image available for generating the three-dimensional scene;
determining a depth map corresponding to the first image based on the first image;
determining a three-dimensional mesh model corresponding to the first image based on the depth map and the first image; and
determining the three-dimensional scene corresponding to the first image based on the first image and the three-dimensional mesh model.

2. The method of claim 1, wherein determining the first image available for generating the three-dimensional scene comprises:
receiving a prompt used to describe the first image; and
generating the first image by inputting the prompt into a first machine learning model.

3. The method of claim 2, further comprising:
performing image super-resolution processing on the first image to update the first image.

4. The method of claim 1, wherein determining the depth map corresponding to the first image comprises:
extracting depth information from the first image; and
determining a depth map for the first image based on the depth information.

5. The method of claim 1, wherein determining the depth map corresponding to the first image comprises:
obtaining the depth map by inputting the first image into a second machine learning model.

6. The method of claim 1, wherein determining the three-dimensional scene corresponding to the first image based on the first image and the three-dimensional mesh model comprises:
generating the three-dimensional scene corresponding to the first image by combining the first image into the three-dimensional mesh model.

7. The method of claim 1, wherein determining the three-dimensional scene corresponding to the first image based on the first image and the three-dimensional mesh model comprises:
generating a video corresponding to the first image based on the first image; and
determining the three-dimensional scene corresponding to the first image based on the video and the three-dimensional mesh model.

8. The method of claim 7, wherein generating the video corresponding to the first image comprises:
generating the video corresponding to the first image by applying the first image to a third machine learning model.

9. The method of claim 8, further comprising:
updating the video by performing image super-resolution processing on a video frame in the video.

10. The method of claim 7, wherein determining the three-dimensional scene corresponding to the first image based on the video and the three-dimensional mesh model comprises:
generating the three-dimensional scene by combining each video frame in the video into the three-dimensional mesh model.

11. An electronic device, comprising:
at least one processor; and
a storage for storing at least one program which, when executed by the at least one processor, causes the at least one processor to:
determine a first image available for generating the three-dimensional scene;
determine a depth map corresponding to the first image based on the first image;
determine a three-dimensional mesh model corresponding to the first image based on the depth map and the first image; and
determine the three-dimensional scene corresponding to the first image based on the first image and the three-dimensional mesh model.

12. The electronic device of claim 11, wherein the at least one program causing the at least one processor to determine the first image available for generating the three-dimensional scene further causes the at least one processor to:
receive a prompt used to describe the first image; and
generate the first image by inputting the prompt into a first machine learning model.

13. The electronic device of claim 12, wherein the at least one program further causes the at least one processor to:
perform image super-resolution processing on the first image to update the first image.

14. The electronic device of claim 11, wherein the at least one program causing the at least one processor to determine the depth map corresponding to the first image further causes the at least one processor to:
extract depth information from the first image; and
determine a depth map for the first image based on the depth information.

15. The electronic device of claim 11, wherein the at least one program causing the at least one processor to determine the depth map corresponding to the first image further causes the at least one processor to:
obtain the depth map by inputting the first image into a second machine learning model.

16. The electronic device of claim 11, wherein the at least one program causing the at least one processor to determine the three-dimensional scene corresponding to the first image based on the first image and the three-dimensional mesh model further causes the at least one processor to:
generate the three-dimensional scene corresponding to the first image by combining the first image into the three-dimensional mesh model.

17. The electronic device of claim 11, wherein the at least one program causing the at least one processor to determine the three-dimensional scene corresponding to the first image based on the first image and the three-dimensional mesh model further causes the at least one processor to:
generate a video corresponding to the first image based on the first image; and
determine the three-dimensional scene corresponding to the first image based on the video and the three-dimensional mesh model.

18. The electronic device of claim 17, wherein the at least one program causing the at least one processor to generate the video corresponding to the first image further causes the at least one processor to:
generate the video corresponding to the first image by applying the first image to a third machine learning model.

19. The electronic device of claim 17, wherein the at least one program further causes the at least one processor to:
update the video by performing image super-resolution processing on a video frame in the video.

20. A non-transitory computer-readable storage medium having a computer program stored thereon, the computer program, when executed by a processor, causing the processor to:
determine a first image available for generating the three-dimensional scene;
determine a depth map corresponding to the first image based on the first image;
determine a three-dimensional mesh model corresponding to the first image based on the depth map and the first image; and
determine the three-dimensional scene corresponding to the first image based on the first image and the three-dimensional mesh model.
